(19) United States
(12) Patent Application Publication
(10) Pub. No.: US 2008/0265466 A1
(43) Pub. Date: Oct. 30, 2008

(54) Injection Impact Compression Moulding

(75) Inventor: Peter Clarke, West Sussex (GB)

Correspondence Address: SMITH-HILL AND BEDELL, P.C., 16100 NW CORNELL ROAD, SUITE 220, BEAVERTON, OR, 97006, US

(73) Assignee: IM-PAK TECHNOLOGIES LIMITED, Chichester, West Sussex (GB)

(21) Appl. No.: 12/088,957

(22) PCT Filed: Oct. 1, 2006
(86) PCT No.: PCT/GB2006/050307

§ 371 Date: Apr. 2, 2008

(30) Foreign Application Priority Data
Oct. 3, 2005 (GB) 0519938.5

(51) Int. Cl. B29C 45/64; B29C 45/03

(52) U.S. Cl. 264/328.1; 425/589

(57) ABSTRACT

A mould for mounting between the relatively movable platens of an injection moulding press for injection impact compression moulding of an article includes a cavity plate formed with a depression, a core plate having a projecting core at least part of the outer surface of which is cylindrical and a closure plate movable relative to the core plate and the cavity plate and having a surface in sealing contact with the cylindrical outer surface of the core. A locking mechanism is provided to lock the closure plate relative to the cavity plate while permitting the core plate to move relative to the cavity plate.

### FIELD OF THE INVENTION

The present invention relates to a mould for injection impact compression moulding (herein referred to as I²CM).

### BACKGROUND OF THE INVENTION

The I²CM moulding process is already known from the Applicants' earlier International Patent Applications WO02/058909 and WO05/068157 and is useful for forming articles having a large length to thickness ratio.

The mould used in the I²CM process comprises a cavity plate formed with a depression, a core plate having a projecting core at least part of the outer surface of which is cylindrical, and a closure plate movable relative to the core plate and the cavity plate and having a surface in sealing contact with the cylindrical outer surface of the core. To carry out the I²CM process, means are provided for applying a force to bias the core plate relative to the cavity plate in a direction to close the mould cavity, the force applied being less than that acting to separate the core plate while plastics material is injected into the mould cavity during an injection phase of the mould cycle.

The depression in the cavity plate has the same shape as the outer surface of the article to be moulded. The projecting core is received within the depression of the cavity plate to form the mould cavity and has an outer shape corresponding to the shape of the inner surface of the article to be moulded. The closure plate is provided to seal between the core and the depression of the cavity plate so that the mould cavity can remain sealed in different positions of the core plate.

In the I²CM moulding process, the mould is closed by applying a relatively small force to the core plate. Plastics material is injected under pressure into the mould cavity to fill the cavity only partially and during this injection the core plate moves back from the cavity plate to allow the plastics material to be admitted. Once a predetermined dose of the plastics material has been injected into the cavity, the core plate is once again moved in a direction to reduce the volume of the mould cavity but this time with sufficient force to cause the plastics material to flow into the thin walled sections of the cavity and to fill the entire cavity. The rebounding of the core plate followed by its advancing a second time towards the cavity plate is referred to as a shuffle and characteristic of the I²CM process. A closure plate separate from the cavity plate and the core plate is required because it is essential during this shuffle for the cavity defined between the core, the depression and the closure plate to remain sealed so that no plastics material can escape.

The I²CM process is not to be confused with injection compression moulding (ICM) which is used to create articles, such as compact discs and lenses, where compression is required after injection primarily to compensate for the shrinkage of the plastics material as it cools. In the ICM process, at the end of the injection phase, the mould cavity is completely full and as the plastic material cools down the volume of the cavity is reduced to achieve a moulded article having good physical properties. By contrast, in the I²CM process, the mould cavity is at first only filled partially with plastics material and the closure of the mould by the press platens is relied upon to force the plastics material rapidly into the thin-walled regions into which the injection pressure alone would not allow it to penetrate.

Hitherto, the I²CM process has been used for moulding articles such as drinking cups and margarine tubs having very thin walls (less than 1 mm). The process is not however restricted to articles having very thin walls and can equally be used for articles such as test tubes and bottle preforms which have relatively thick walls, but still a large length to thickness ratio.

Moulding a long thin cylindrical article with a significant wall thickness by the I²CM process should in principle be no different from moulding a drinking cup or a margarine tub. However, in practice the difference is that a shuffle of only a few millimetres is required when a cup is being formed but the shuffle movement may need to be a few centimetres when forming a test tube or a bottle preform. This significantly greater shuffle movement of the core makes it difficult to maintain the mould cavity sealed.

### SUMMARY OF THE INVENTION

With a view to mitigating the foregoing problem, there is provided in accordance with a first aspect of the present invention an injection impact compression mould for mounting between the relatively movable platens of an injection moulding press for moulding of an article, the mould comprising a cavity plate formed with a depression, a core plate having a projecting core at least part of the outer surface of which is cylindrical, a closure plate movable relative to the core plate and the cavity plate and having a surface in sealing contact with the cylindrical outer surface of the core, and means for applying a force to bias the core plate relative to the cavity plate in a direction to close the mould cavity, said force being less than the force acting to separate the core plate while plastics material is injected into the mould cavity during an injection phase of the mould cycle, characterised in that a locking mechanism is provided to lock the closure plate relative to the cavity plate during the injection phase of the moulding cycle while permitting the core plate to move relative to the cavity plate.

In a second aspect of the invention, there is provided a method as hereinafter set forth in claim 7 of the appended claims.

In the prior art, because of the small rebound movement of the core plate, adequate sealing of the cavity during compression could be achieved by the use of a spring acting between the core plate and the closure plate to urge the closure plate towards the cavity plate. The large rebound movement of the core plate when moulding a bottle preform makes it is difficult to apply a force to the closure plate from the core plate side to keep the cavity sealed as the core plate rebounds. The present invention overcomes this problem by holding the closure plate in its closed position from the cavity plate side instead of pushing it from the core plate side.

It should be mentioned that in JP-1268080 there has been proposed a mould for use in an ICM moulding process which includes means for locking the cavity plate relative to the closure plate. In the latter mould, the locking means are provided for the purpose of withstanding the very high pressure acting to separate the cavity plate from the closure plate during the compression phase of the cycle after injection has been completed. By contrast, the locking mechanism in the present invention is primarily aimed at avoiding leakage from the mould cavity during the injection phase caused by the large movement of the core during the shuffle part of the moulding cycle. The mould of JP-1268080 cannot of course be used in an I²CM moulding cycle as it has no means for allowing the core to rebound under the action of the injection pressure.

In the manufacture of PET two-litre bottles, as used for water and carbonated beverages, it is common to adopt a two stage process. In the first stage, one produces, usually by injection moulding, a preform having the shape of a test-tube with an external threat at one end. In the second stage, the preform is expanded to form the finished bottle by a combination of mechanical stretching and blow moulding. The external thread at one end is used for the screw cap of the bottle and it is not modified during the second stage of processing.

Such a preform differs from cups and margarine tubs on account of the external screw thread. It will be obvious that if one attempted to produce an article with an external screw thread, or any other kind of undercut, in a mould formed in one piece, it would be impossible to withdraw the article from the mould once it has solidified. It is therefore essential to form at least the part of the mould cavity defining the screw thread in two or more sections that can be moved apart so that they may be disengaged from the moulded article. These mould parts are normally referred to as splits and are carried by a splits plate.

No attempt has previously been made to use the I²CM process to produce an article having an undercut, requiring the use of a splits plate.

It is an important advantage of the invention that it allows a splits plate to be disposed between the closure plate and the cavity plate.

It is known from conventional injection moulding, for the splits to interlock mechanically with the cavity plate to prevent the splits from being separated from one another when the mould is closed. However, the difficulty presented by the need for splits when moulding a bottle preform by the I²CM process is that the high pressure applied by the core during the compression stroke acts to separate the splits before the mould is fully closed. The preferred embodiment of the invention avoids this problem by locking the splits plate and the closure plate to the cavity plate.

Though the splits plate may be permanently secured to the cavity plate, it is preferred for the splits plate to be movably mounted on the closure plate.

The locking mechanism is preferably formed of at least one pin projecting from the closure plate into a bore in the cavity plate, selectively operable collets being provided in the bore to engage an undercut in the head of the pin.

The collets, which may be operated mechanically, electrically, hydraulically or pneumatically, preferably apply a preload to clamp the closure plate against the cavity plate.

### BRIEF DESCRIPTION OF THE DRAWINGS

The invention will now be described further, by way of example, with reference to the accompanying drawings, in which:

FIGS. 1 to 11 all show a section through a mould of the present invention at different stages in the moulding of a preform by the I²CM process.

### DETAILED DESCRIPTION OF THE PREFERRED EMBODIMENT

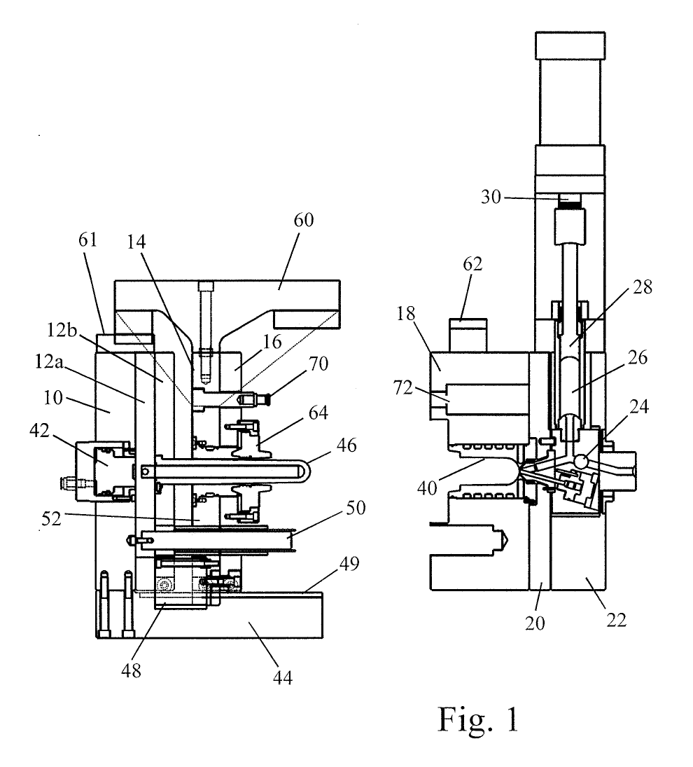

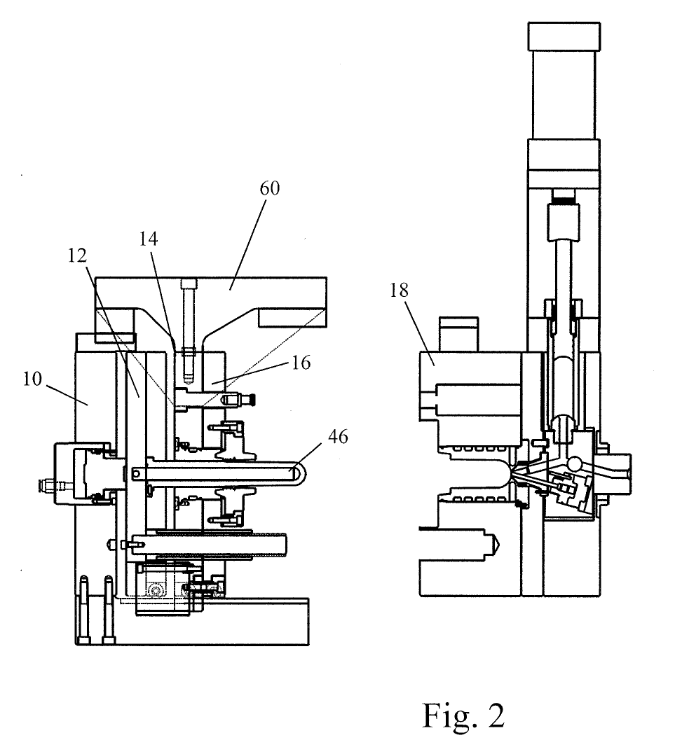

The mould shown in the drawings is made up of two sets of plates which are shown in FIGS. 1 and 2 separated from one another. The set of plates shown to be left is mounted on the moving platen of an injection moulding press while the set of plates shown to the right is mounted on the fixed platen, which is connected to an injection screw (not shown).

The set of plates mounted on the movable platen of the injection moulding press comprises a support plate 10, a core plate 12, a closure plate 14 and a splits plate 16. The stationary set of plates comprises a cavity plate 18, a hot runner plate 20 and a dosing cylinder plate 22. Unlike the plates mounted on the moving platen, the stationary set of plates never move relative to one another and may be regarded as a single subassembly. The purpose of the hot runner plate 20 and the dosing cylinder plate 22 is to inject a predetermine dose of plastics material into the mould cavity at the appropriate time in the operating cycle to be described below.

Within the stationary subassembly, a molten plastics material is injected by the injection screw into the dosing cylinder plate 22. The latter incorporates valving 24 to direct the incoming plastics material into a dosing cylinder 26 of predetermined capacity. Once the dosing cylinder 26 is full, the valving 24 is operated to disconnect the cylinder 26 from the injection screw and connect it instead to a depression 40 in the cavity plate 18 which constitutes the outer surface of the mould cavity. A piston 28 connected to an actuator 30 displaces the molten plastics from the cylinder 26 and the plastics material then flows by way of heated conduits in the hot runner plate 20 to the mould cavity.

The support plate 10 fixed to the moving platen of the injection moulding press has mounted within it an air cylinder 42. A horizontal platform 44 is also bolted to the underside of the support plate 10, its purpose being to carry and guide the core plate 12.

The core plate 12 has a core 46 projecting forwards from it, the core defining the inner surface of the mould cavity. The core 46 comprises a hollow cylinder with a closed hemispherical front end and its rear end has a flange sandwiched between separate plates 12a and 12b that are permanently secured to one another to form the core plate 12. The two-part construction of the core plate 12 is to permit a cooling medium to flow through the core 46. The core plate 12 is mounted on a carriage 48 that follows tracks 49 of the support platform 44 thereby enabling the core and the core plate to move relative to the support plate 10 from left to right in the plane of the drawing.

The closure plate 14 is guided for movement relative to the core plate 12 on pillars 50. The closure plate 14 carries a sealing element 52 that mates with the cylindrical outer surface of the core 46 and seals against it at all times. The closure plate 14 is suspended from two arms 60 (only one been visible in the drawings) which rest with their rear end on guide surface 61 on the support plate 10 and which ride at their front end on guide surfaces 62 secured to the cavity plate 18. The purpose of the support arms 60 is to ensure correct alignment of the core 46 with the cavity plate 18. Also guided on the support pillars 50 is the splits plate 16 which carries a pair of splits 64.

Pins 70 are mounted on the closure plate 14 and pass through the splits plate 16 to engage in bores 72 formed in the cavity plate 18. Hydraulically operated collets (not shown) near the entrance to the bores 72 grip and preferably apply a preload to the ends of the pins 72, to clamp the closure plate 14 and the splits plate 16 to the cavity plate 18 at certain times during the operating cycle.

At the commencement of an injection moulding cycle, the various components of the mould adopt the positions shown in FIG. 1. Here, the core plate 12 rests against the support plate 10 and the splits plate 16 rests against the closure plate 14, while a gap remains between the core plate 12 and the closure plate 14. At this point, the mould is fully open and the article moulded in the preceding cycle has just been ejected off the core 46. It will be noted that the splits 64 have a conically tapering extensions received in the sealing member 52 of the closure plate so that the splits 64 are held together radially.

The first step in the cycle is shown in FIG. 2 in which the air cylinder of 42 is activated to push the core plate 12 away from the support plate 10.

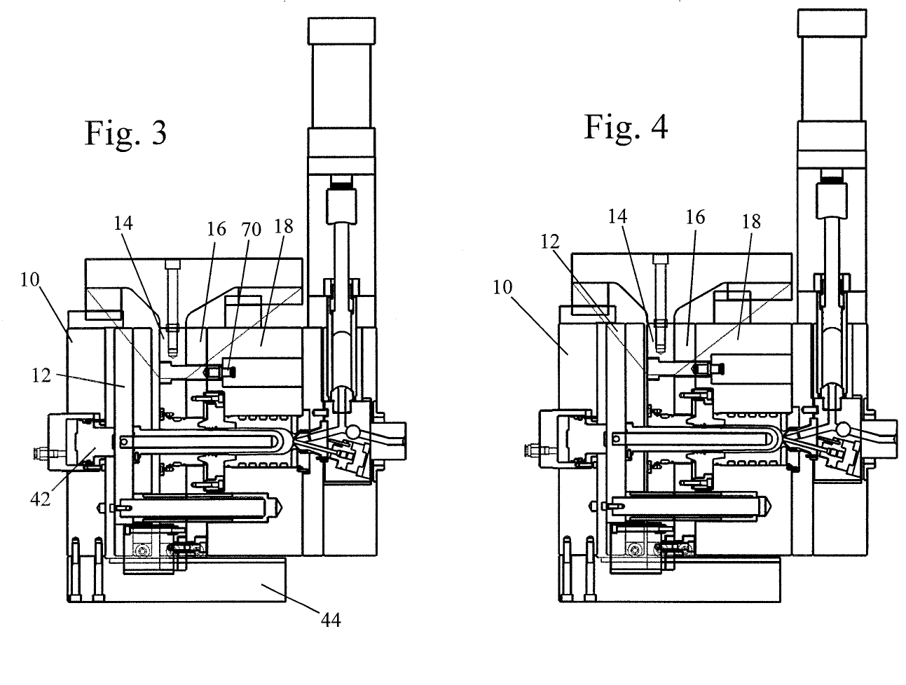

In the next step, shown in FIG. 3, the moving platen of the injection moulding press advances the core plate 12, the closure plate 14 and the splits plate 16 towards the cavity plate 18. The first contact occurs between the arm 60 and the guides 62 and this ensures that all the plates are aligned with one another and parallel to one another.

When the pins 70 of the cavity plate 14 engage in the bores 72 of the cavity plate 18, the collets mentioned previously are operated to lock the closure plate 14 and the splits plate 16 to the cavity plate 18.

It will be noted that the splits 64 also have formations projecting from their front end which are received in a conically tapering recess in the opposing face of the cavity plate 18. Once again, this interlocking prevents the splits from separating while the mould is closed. The locking of the closure plate 14 and the splits plate 16 to the cavity plate 18, not only maintains the cavity sealed but prevents the splits 64 from separating during the subsequent movements of the core plate 12.

Continued advancement of the support plate 10 by the moving platen of the injection moulding press displaces the core plate 12 to the position shown in FIG. 4 in which the core fully penetrates into the depression 40 of the cavity plate 18 and reduces the mould cavity to its minimum volume, this volume corresponding to the shape of the desired preform. The preform has a test tube like end portion defined between the depression 40 and the core 46 and a screw threaded portion defined between the splits 64 and the outer surface of the core 46. The axial end of the cavity is defined by the closure plate 14. The pressure being applied at this point to maintain the cavity closed is only the pressure of the air cylinder 42, not the pressure of the press of the injection moulding press.

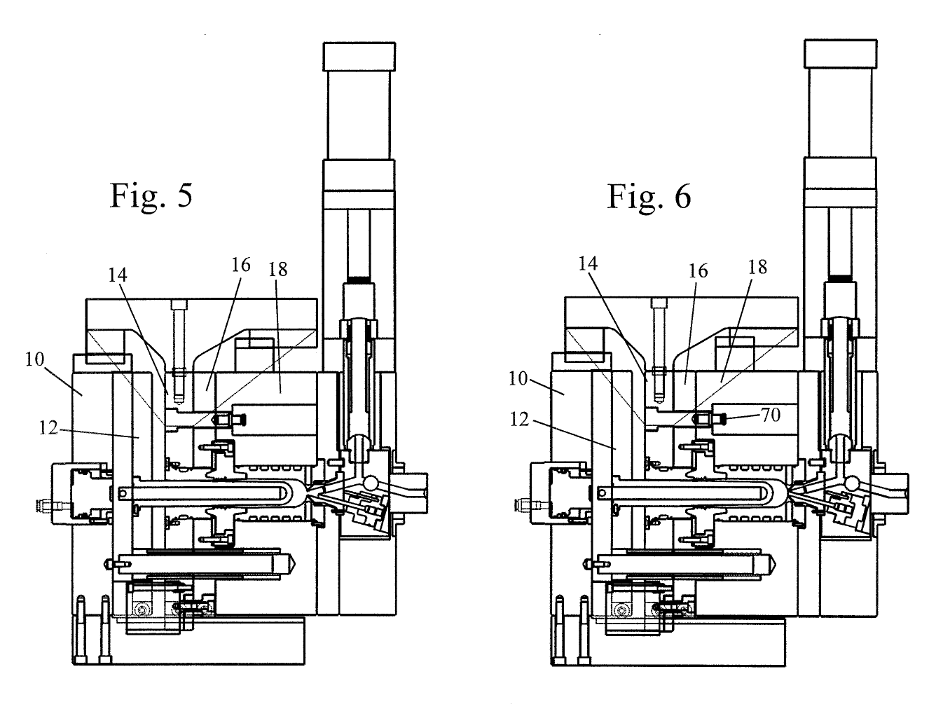

In FIG. 5, the actuator 30 is operated to displace the piston 28 and inject plastics material in the manner described previously from the cylinder 26 into the mould cavity. As the plastics material is injected, it cannot flow into the thin walled portions of the cavity and instead the pressure build-up causes the core 46 and the core plate 12 to rebound away from the cavity plate 18, thereby widening the gap between the core plate 12 and the closure plate 14 while closing the gap between the core plate 12 and the support plate 10. During this time, the closure plate cannot move because it is locked to the cavity plate 18 by the collets acting on the pins 70.

With plastics material now filling the bottom of the cavity and filling the sides of cavity either only partially or not at all, the core 46 is driven into the cavity by the force of the press of the injection moulding press acting on the support plate 10. This movement forces the plastics material present in the cavity up the side walls and into the screw thread defined by the splits 64. Because the cavity was reduced to its minimum volume before plastics material was injected into it, little air remains in the cavity prior to the cavity being filled and such air as is present can readily be vented during the compression of the plastics material.

As earlier mentioned, the length of the compression stroke of the core when manufacturing a preform for a two litre bottle is of the order of 2.5 cms, which is considerably greater than when making thin-walled cups and margarine containers. With thin-walled articles, it was only found necessary to regulate the pressure applied to the core plate to ensure that it was sufficient to overcome the resistance to flow of the plastics material. However, with the longer stroke required to manufacture a bottle preform, it has been found that, to achieve mouldings of consistently high quality, it is not sufficient to regulate the pressure of the press but it is important to regulate the velocity profile of the core. Hitherto, because of the constant pressure and the geometry of the press, the velocity merely decreased monotonically as the core approached its final position. By contrast, it has been found that at the commencement of the compression stroke, it is desirable for the core velocity to be increased and for the core to be decelerated more sharply as it approaches its final position. In this way, the bulk of the cavity is filled as rapidly as possible, allowing little time for the skin to cool down in the cylindrical part of the preform and the final stage of the compression at high pressure ensures that material continues to flow to form the screw thread at the end of the cylindrical portion. One may employ a press having control over the speed of movement of the platen, as the velocity profile may need to be modified to suit the particular configuration of the article being moulded, but if the press does not offer such functionality then the same result may be achieved by incorporating additional hydraulic cylinders within the mould to move parts of the mould relative to the machine platen with controllable velocity.

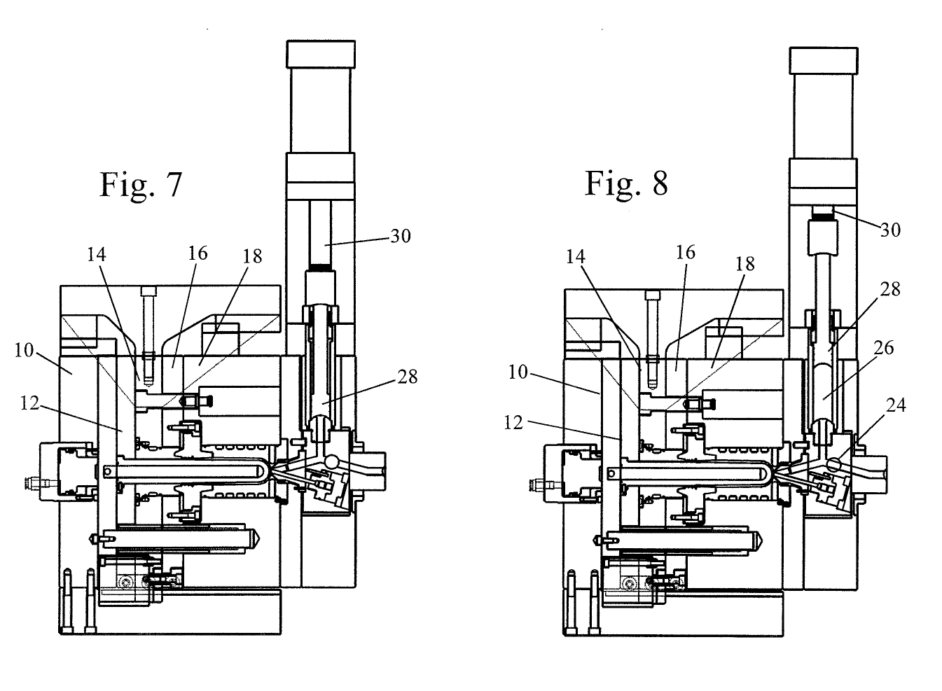

The closed position of the mould is shown in FIGS. 7 and 8. In both these figures, the plastics material which has been injected into the cavity has been compressed by the movement of the core and now occupies the entire mould cavity. FIG. 8 shows that while the mould is in this position the valving 24 is reversed so that once again plastics material from the injection screw is readmitted into the dosing cylinder 26, in readiness for the next cycle.

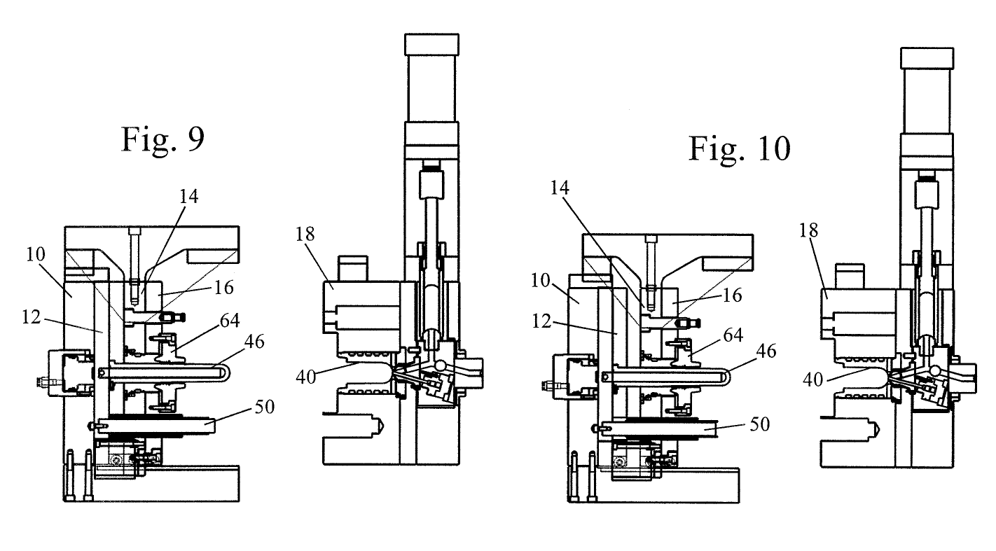

In the next step, shown in FIG. 9, the mould is fully opened by first releasing the collets acting on the pins 70 and then withdrawing all four of the movable plates 10 to 16 away from the cavity plate 18. At this stage, the splits 64 have still not been separated and therefore the moulded article is pulled out of the depression 40 in the cavity plate 18 and remains around the core 46.

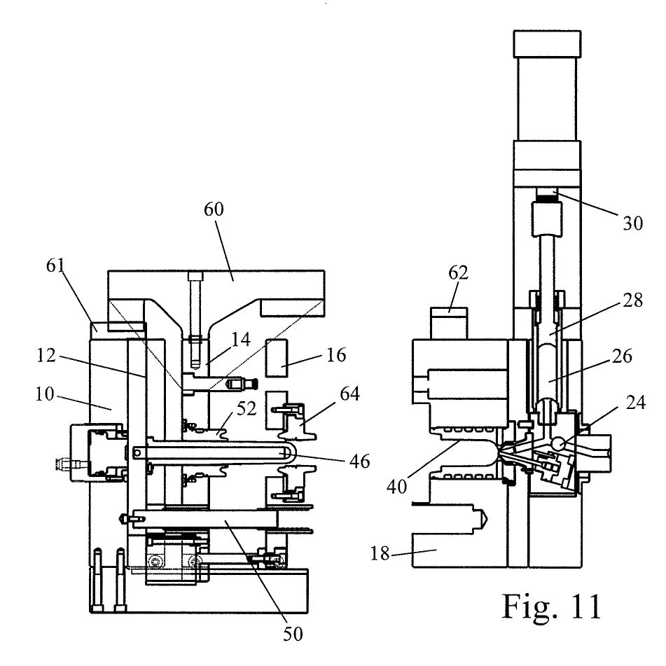

As shown in FIG. 10, the closure plate 14 is next moved away from the core plate 12 to commence the ejection of the moulded article off the core 46 and this ejection is continued in the next step, shown in FIG. 11, by the movement of the splits plate 16 away from the closure plate 14. Once the interlock between the splits 64 and the sealing member 52 has been disengaged, the splits 64 are separated by an actuator (not shown) to release the formed article.

Once the splits plate 16 returns to its position against the closure plate 14, after the moulded article has been ejected, the components again adopt their position shown in FIG. 1, ready for the commencement of the next operating cycle.

1. An injection impact compression mould for mounting between the relatively movable platens of an injection moulding press for moulding of an article, the mould comprising a cavity plate (18) formed with a depression (40), a core plate (12) having a projecting core (46) at least part of the outer surface of which is cylindrical, a closure plate (14) movable relative to the core plate (12) and the cavity plate (18) and having a surface in sealing contact with the cylindrical outer surface of the core, and means (42) for applying a force to bias the core plate (12) relative to the cavity plate (18) in a direction to close the mould cavity, said force being less than the force acting to separate the core plate while plastics material is injected into the mould cavity during an injection phase of the mould cycle, characterised in that a locking mechanism (70) is provided to lock the closure plate (14) relative to the cavity plate (18) during the injection phase of the moulding cycle while permitting the core plate to move relative to the cavity plate.

2. A mould as claimed in claim 1, wherein a splits plate (16) is disposed between the closure plate (14) and the cavity plate (18), the locking mechanism (70) serving to lock both the closure plate (14) and the splits plate (16) to the cavity plate (18).

3. A mould as claimed in claim 2, the splits plate (16) is movably mounted on the closure plate (14).

4. A mould as claimed in any preceding claim, wherein the locking mechanism is formed of at least one pin (70) projecting from the closure plate (14) into a bore (72) in the cavity plate (18) and selectively operable collets are provided in the bore (72) to engage an undercut in the head of the pin (70).

5. A mould as claimed in claim 4, wherein the collets are mechanically, electrically, hydraulically or pneumatically.

6. A mould as claimed in claim 5, wherein the collets apply a preload to clamp the closure plate against the cavity plate.

7. A method of injection impact compression moulding of an article, using a mould which comprises a cavity plate formed with a depression, a core plate having a projecting core at least part of the outer surface of which is cylindrical, and a closure plate movable relative to the core plate and the cavity plate and having a surface in sealing contact with the cylindrical outer surface of the core, the method comprising the steps of
a) fully closing the mould by urging the cavity plate, the core plate and the closure plate against one another,
b) injecting plastics material into the mould cavity defined between the core and the depression in the cavity while allowing the core plate to move relative to the cavity plate under the action of the injection pressure, the injected plastics material filling only part of the mould cavity, and
c) closing the mould by applying sufficient pressure to cause the injected plastics material to flow and occupy the whole of the mould cavity,
characterised by the step of
d) locking the closure plate to the cavity plate at least during the injection step (b).
